(19) United States
(12) Patent Application Publication
(10) Pub. No.: US 2020/0272653 A1
(43) Pub. Date: Aug. 27, 2020

(54) APPARATUS FOR SEARCHING FOR CONTENT USING IMAGE AND METHOD OF CONTROLLING SAME

(71) Applicant: Samsung Electronics Co., Ltd., Gyeonggi-do (KR)

(72) Inventors: Heuijin LEE, Gyeonggi-do (KR); Yunhyun KIM, Gyeonggi-do (KR); Byeongjun PARK, Gyeonggi-do (KR); Myeongseok HYEON, Gyeonggi-do (KR); Jeonghyun LEE, Gyeonggi-do (KR)

(21) Appl. No.: 16/792,405

(22) Filed: Feb. 17, 2020

(30) Foreign Application Priority Data
Feb. 22, 2019 (KR) 10-2019-0021349

(51) Int. Cl. G06F 16/532; G06F 3/0482; G06K 9/62; G06F 3/0481; G06F 16/538; G06N 20/00

(52) U.S. Cl. CPC G06F 16/532; G06F 3/0482; G06K 9/6215; G06F 2203/04803; G06F 16/538; G06N 20/00; G06F 3/04817

(57) ABSTRACT

An electronic device includes: a display; a memory; and at least one processor, wherein the at least one processor is configured to display a first image and one or more objects on the display, acquire a second image in response to a first user input, acquire first information based on the second image and a representing type of at least one object among the one or more objects, transmit the acquired first information to a server, receive information on at least one third image related to the first information from the server, display the information on the at least one third image on the display, receive a second user input for selecting the at least one third image, and change the first image into the at least one third image and display the at least one third image based on the second user input. Other various embodiments are possible.

### CROSS-REFERENCE TO RELATED APPLICATION(S)

This application is based on and claims priority under 35 U.S.C. 119 to Korean Patent Application No. 10-2019-0021349, filed on Feb. 22, 2019, in the Korean Intellectual Property Office, the disclosure of which is herein incorporated by reference in its entirety.

### BACKGROUND

### 1. Technical Field

The instant disclosure generally relates to an electronic device for searching for content using an input image and a method of controlling the same.

### 2. Related Art

Modern day electronic devices are capable of various service and functions. For example, uses of portable electronic devices such as smart phones have gradually increased. In order to increase these devices' value and satisfy various user needs, communication service 20 providers or electronic device manufacturers have competitively developed electronic devices that are differentiated from those of other companies. Accordingly, various functions provided through electronic devices have become increasingly sophisticated.

### SUMMARY

A user of an electronic device may configure a background screen (in other words, a background image or wallpaper) on a display included in the electronic device using an image stored in a predetermined application (for example, gallery application) or an image found via the Internet. The user of the electronic device may further configure the background screen or a 30 theme package (for example, wallpaper, icons, fonts, and a lock screen) on the display according to a user's preference by downloading the background screen and the theme package from various theme stores (for example, Samsung Themes application) and configuring the downloaded background screen and theme package on the electronic device.

A method of searching for an image similar to a base or input image of the electronic device may include the operation of transmitting image data to a server to process a large amount of data and receiving found image data from the server. However, in an environment in which data communication is poor, it takes a lot of time for the electronic device to transmit image data for the search to the server and thus it may take an excessively long time to acquire a search result.

Searching for the background image to be applied to the display of the electronic device may be done using a search keyword. However, when the search keyword is simple or generic, search results may be excessively huge. Accordingly, the user of the electronic device may have difficulties selecting the appropriate words in order to acquire an accurate search result.

Further, when the electronic device searches for a theme package (for example, a background image and a package including other theme elements such as icons or fonts) through a keyword search, it may be difficult to search for other theme elements included in the theme package using the same keyword. Accordingly, in order to search for the other desired theme elements, the user of the electronic device may be inconvenienced in that the user would have to a theme package individually from the search result lists and check if the selected theme package has the desired theme elements.

In accordance with an aspect of the disclosure, an electronic device is provided. The electronic device includes: a display; a memory; and at least one processor, wherein the at least one processor is configured to display a first image and one or more objects on the display, acquire a second image in response to a first user input, acquire first information based on the second image and a representing type of at least one of the one or more objects, transmit the acquired first information to a server, receive information on at least one third image related to the first information from the server, display the information on the at least one third image on the display, receive a second user input for selecting the at least one third image, and change the first image into the at least one third image and display the at least one third image on the basis of the second user input.

In accordance with another aspect of the disclosure, a method of controlling an electronic device is provided. The method includes: displaying a first image and one or more objects on a display; acquiring a second image in response to a first user input; acquiring first information based on the second image and a representing type of at least one of the one or more objects; transmitting the acquired first information to a server; receiving information on at least one third image related to the first information from the server; displaying the information on the at least one third image on the display; receiving a second user input for selecting the at least one third image; and changing the first image into the at least one third image and displaying the at least one third image on the display on the basis of the second user input.

In accordance with another aspect of the disclosure, an electronic device is provided. The electronic device includes: a memory; and at least one processor, wherein the at least one processor is configured to receive information on a first image and a representing type of at least one object displayed on a display of an external electronic device from the external electronic device, generate first information based on the first image and the representing type, and transmit information on at least one second image among a plurality of images stored in the memory to the external electronic device on the basis of a determination of similarity using the generated first information.

Additional aspects will be set forth in part in the description which follows and, in part, will be apparent from the description, or may be learned by practice of the presented embodiments.

### BRIEF DESCRIPTION OF THE DRAWINGS

The above and other aspects, features, and advantages of the disclosure will be more apparent from the following detailed description taken in conjunction with the accompanying drawings, in which:

FIG. 1 is a block diagram illustrating an electronic device in a network environment according to various embodiments of the disclosure;

FIG. 2 is a block diagram illustrating an example of describing an operation for generating a customized model through machine learning using a theme package stored in a theme store according to an embodiment of the disclosure;

FIG. 3A is a block diagram illustrating an example of an operation in which an electronic device receives recommended theme information similar to a first image from a server using a customized model according to an embodiment of the disclosure;

FIG. 3B is a block diagram illustrating an example of an operation in which an electronic device receives recommended theme information similar to a first image using a customized model from the server according to an embodiment of the disclosure;

FIG. 3C is a block diagram illustrating an example of a theme information searching system including an electronic device and a recommendation system according to an embodiment of the disclosure;

FIG. 4 is a flow chart illustrating an operation in which an electronic device receives at least one second image related to a first image using a customized model according to an embodiment of the disclosure;

FIG. 5 are views illustrating an example of a second image (or a theme package) related to a first image according to an embodiment of the disclosure;

FIG. 6 is a flow chart illustrating an operation in which an electronic device acquires a first image for changing a background image through a camera according to an embodiment of the disclosure;

FIG. 7A is a view illustrating an example of an operation in which an electronic device receives at least one second image using a first image acquired through a camera according to an embodiment of the disclosure;

FIG. 7B is a view illustrating an example of an operation in which an electronic device receives at least one second image using a first image acquired through a camera according to an embodiment of the disclosure;

FIG. 7C is a view illustrating an example of an operation in which an electronic device receives at least one second image using a first image acquired through a camera according to an embodiment of the disclosure;

FIG. 7D is a view illustrating an example of an operation in which an electronic device receives at least one second image using a first image acquired through a camera according to an embodiment of the disclosure;

FIG. 7E is a view illustrating an example of an operation in which an electronic device receives at least one second image using a first image acquired through a camera according to an embodiment of the disclosure;

FIG. 8 is a flow chart illustrating an example in which an electronic device receives at least one second image through a third application according to an embodiment of the disclosure;

FIG. 9A is a view illustrating an operation in which an electronic device receives at least one second image through a third application according to an embodiment of the disclosure;

FIG. 9B is a view illustrating an operation in which an electronic device receives at least one second image through a third application according to an embodiment of the disclosure;

FIG. 9C is a view illustrating an operation in which an electronic device receives at least one second image through a third application according to an embodiment of the disclosure;

FIG. 9D is a view illustrating an operation in which an electronic device receives at least one second image through a third application according to an embodiment of the disclosure;

FIG. 9E is a view illustrating an operation in which an electronic device receives at least one second image through a third application according to an embodiment of the disclosure;

FIG. 10A is a view illustrating an operation in which an electronic device receives at least one second image through a third application according to an embodiment of the disclosure;

FIG. 10B is a view illustrating an operation in which an electronic device receives at least one second image through a third application according to an embodiment of the disclosure;

FIG. 11A is a view illustrating an operation in which an electronic device receives at least one second image through a third application according to an embodiment of the disclosure;

FIG. 11B is a view illustrating an operation in which an electronic device receives at least one second image through a third application according to an embodiment of the disclosure;

FIG. 12 is a flow chart illustrating an operation in which an electronic device receives at least one second image on the basis of a partial area of a first image according to an embodiment of the disclosure;

FIG. 13A is a view illustrating an operation in which an electronic device receives at least one second image on the basis of a partial area of a first image according to an embodiment of the disclosure;

FIG. 13B is a view illustrating an operation in which an electronic device receives at least one second image on the basis of a partial area of a first image according to an embodiment of the disclosure;

FIG. 13C is a view illustrating an operation in which an electronic device receives at least one second image on the basis of a partial area of a first image according to an embodiment of the disclosure;

FIG. 14A is flow chart illustrating an operation in which an electronic device receives recommended theme information similar to a second image according to an embodiment of the disclosure; and

FIG. 14B is flow chart illustrating an operation in which an electronic device transmits recommended theme information similar to a first image to an external electronic device according to an embodiment of the disclosure.

### DETAILED DESCRIPTION

An electronic device according to an embodiment can transmit information for an image search (for example, feature vector) to a server and rapidly acquire a search result even in an environment in which data communication is poor by storing a customized model for the image search in a memory.

An electronic device according to an embodiment can accurately and conveniently acquire a search result of a background image or a theme package by employing a deep learning-based search of an image.

An electronic device according to an embodiment can search for a theme package including various theme elements (for example, icons and fonts) on the basis of applied theme information.

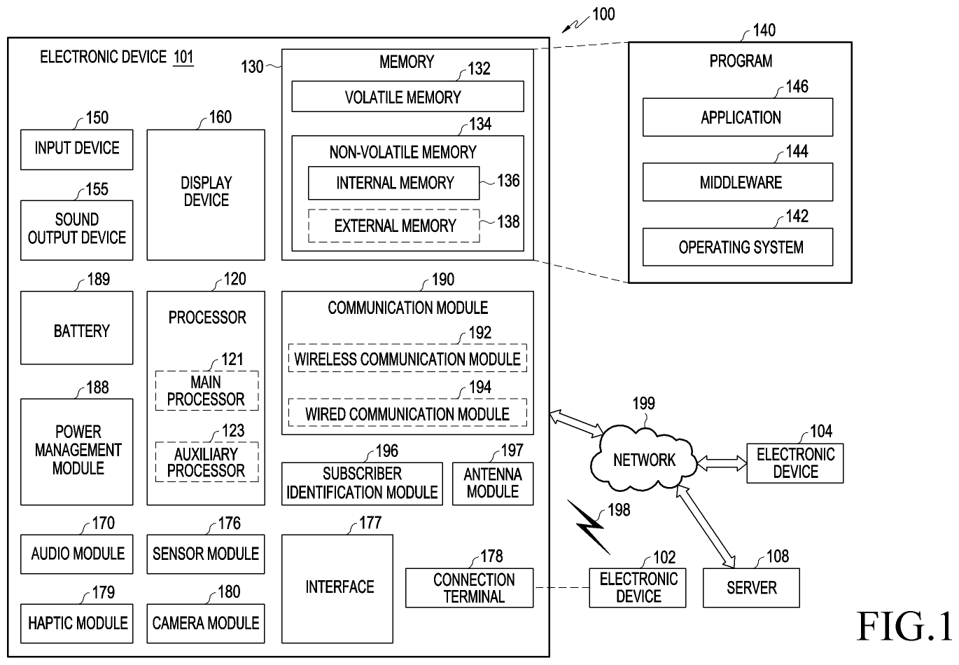

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing recordings, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his or her tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

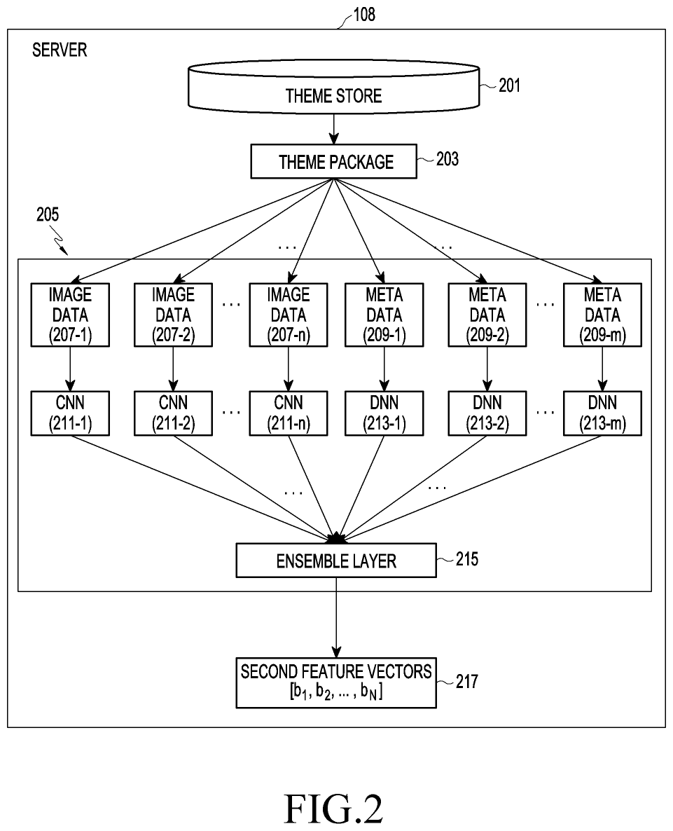

FIG. 2 is a block diagram illustrating an example of an operation of generating a customized model 205 through machine learning using a theme package 203 stored in a theme store 201 according to an embodiment.

Referring to FIG. 2, the server 108 according to an embodiment may store the theme store 201 and a pre-learned model (for example, a Convolutional Neural Networks (CNN) model or a Deep Neural Networks (DNN) model). Although shown as a component of the server 108, the theme store 201 may be a separate server different from the server 108. The CNN model according to an embodiment may be a model in which one or more feature vectors of image (or character) are extracted by applying convolutional layers, pooling layers, and fully connected layers to the input image (or character) data. The CNN model may include data on a plurality of (for example, one the order of millions or billions) pre-learned images. The DNN model according to an embodiment may be a model that includes a plurality of hidden layers between an input layer and an output layer. In the disclosure, the case using a Resnet algorithm (for example, Resnet-18 algorithm) is described as an example of the CNN model. In the disclosure, the term “feature vector” may be interchangeable with the term “latent vector.”

According to an embodiment of the disclosure, the theme store 201 may store a plurality of theme packages (for example, the theme package 203). For example, a particular theme package 203 may include at least one of an icon image, a wallpaper image, a lock screen image, a font image, and label information. In other words, the theme package 203 according to an embodiment may be a dataset including at least one of a background screen, an icon, a character, and a lock screen for display in the electronic device. The label information according to an embodiment may include at least one piece of title information of each theme package input by a theme package (or background image) developer, category information, developer information, manufactured date information, or compatibility information (for example, Android version information).

The server 108 according to an embodiment may acquire the theme package 203 from the theme store 201 and acquire a plurality of image data 207-1 to 207-n and a plurality of metadata 209-1 to 209-m. For example, the plurality of image data 207-1 to 207-n may correspond to the wallpaper image, the lock screen image, the icon image, and font image included in the theme package 203. According to an embodiment, the plurality of metadata 209-1 to 209-m may correspond to title information, category information, developer information, manufactured date information, or capability information included in the label information of the theme package 203.

The server 108 according to an embodiment may learn each of the CNN models 211-1 to 211-n using the plurality of extracted image data 207-1 to 207-n. The learning according to an embodiment may include an operation of repeatedly controlling weights by comparing output values of the CNN models 211-1 to 211-n with actual target values (for example, label information) through, for example, a gradient descent method. For example, the server 108 may store a plurality of theme packages and repeatedly control weights using a plurality of images acquired from the plurality of theme packages.

A weight of one of the CNN models 211-1 to 211-n according to an embodiment may be expressed as, for example, a matrix (for example,

$$\begin{matrix}[ {w}_{11} ⋯ {w}_{1 L} ] \\ [ {w}_{21} ⋯ {w}_{2 L} ] \\ ⋮\end{matrix}$$

$$[ {w}_{K 1} ⋯ {w}_{KL} ] )$$

as shown in [Table 1]. For example, K may be 128.

TABLE 1

| Index | 1 | 2 | 3 | . . . | L |
|---|---|---|---|---|---|
| 1 | −0.099 | | | . . . | 0.0384 |
| 2 | −0.007 | | | . . . | −0.121 |
| . . . | . . . | . . . | . . . | . . . | . . . |
| K | −0.652 | 0.3791 | 0.4977 | . . . | 0.2218 |

The server 108 according to an embodiment may have a weight matrix for each of the CNN models 211-1 to 211-n.

The server 108 according to an embodiment may generate a plurality of first output values by applying the learned CNN models 211-1 to 211-n to the plurality of extracted image data 207-1 to 207-n. The server 108 according to an embodiment may generate a plurality of 10 second output values by applying the DNN models 213-1 to 213-m to the plurality of extracted metadata 209-1 to 209-m. According to an embodiment, at least one of the first output value and the second output value may be expressed as a vector (for example [c₁ c₂ . . . c_{M}]) as shown in [Table 2]. According to an embodiment, the CNN models may be applied to the plurality of metadata 209-1 to 209-m.

TABLE 2

| image | c₁ | c₂ | c₃ | . . . | c_{M} |
|---|---|---|---|---|---|
| 1 | 0.7512 | 0.3008 | 0.0006 | . . . | 0.6446 |
| 2 | 0.5477 | 0.084 | 0.3272 | . . . | 1.8809 |
| 3 | 1.386 | 0.76 | 1.0679 | . . . | 1.2198 |
| . . . | . . . | . . . | . . . | . . . | . . . |

In [Table 2], the number of the image item may be a number for identifying each of the plurality of theme packages stored in the theme store 201. For example, a background image (for example, image 1) of a first theme package (for example, the theme package 203) may have a vector of [0.7512, 0.3008, 0.0006; . . . , 0.6446], and a background image (for example, image 2) of a second theme package (not shown) may include a vector of [0.5477, 0.084, 0.3272; . . . , 1.8809].

The server 108 according to an embodiment may generate at least one second feature vector 217 by combining a plurality of first output values from the plurality of CNN models 211-1 to 211-n and a plurality of second output values from the plurality of DNN models 213-1 to 213-m through an ensemble layer. One second feature vector 217 may correspond to one theme package 203.

The ensemble layer according to an embodiment may be a model for performing dimension reduction and/or concatenation for a plurality of feature vectors (for example, first and second output values) and generating a feature vector (for example, the second feature vector 217) combined by the dimension reduction and/or concatenation. The second feature vector 217 according to an embodiment may be expressed as a vector (for example [b₁ . . . b_{N}]) as shown in [Table 3].

TABLE 3

| package | b₁ | b₂ | b₃ | . . . | b_{N} |
|---|---|---|---|---|---|
| 1 | 0.312989 | 1.317116 | 2.677762 | . . . | 0.186756 |
| 2 | 2.122758 | 1.885774 | 1.103456 | . . . | 0.659429 |
| 3 | 0.916693 | 0.54078 | 0.477263 | . . . | 0.547662 |
| . . . | . . . | . . . | . . . | . . . | . . . |

In the instant disclosure, a model including the learned CNN models 211-1 to 211-n, the DNN models 213-1 to 213-m, and the ensemble layer 215 may be referred to as the customized model 205. According to an embodiment, the server 108 may pre-store a plurality of second feature vectors (for example, the second feature vector 217) corresponding to a plurality of respective theme packages generated using a plurality of image data (for example, the image data 207-1 to 207-n) and a plurality of metadata (for example, the metadata 209-1 to 209-m) extracted from a plurality of various theme packages (for example, the theme package 203) through the customized model 205.

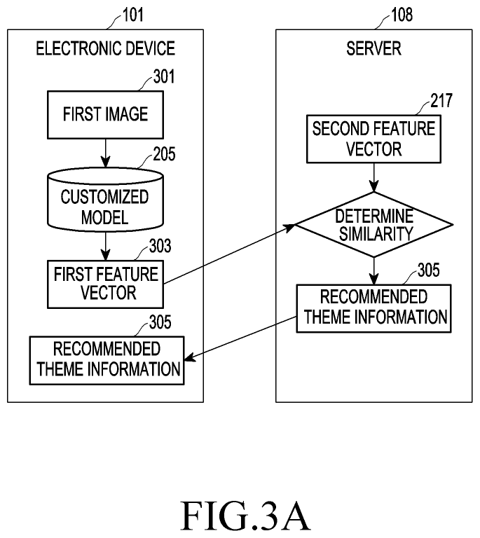

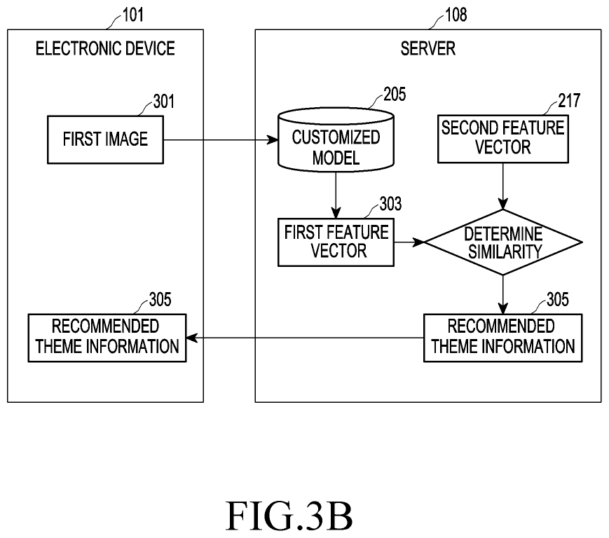

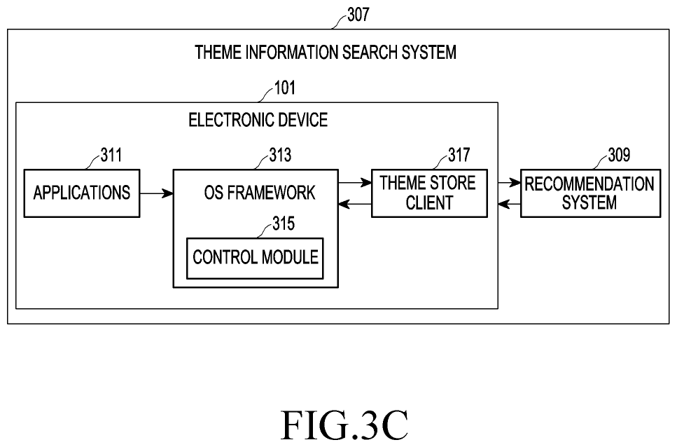

FIG. 3A is a block diagram illustrating an example of an operation in which the electronic device 101 receives recommended theme information 305 similar to a first image 301 from the server 108 using the customized model 205 according to an embodiment, and FIG. 3B is a block diagram illustrating an example of an operation in which the electronic device 101 receives recommended theme information 305 similar to a first image 301 from the server 108 using the customized model 205 according to an embodiment.

Referring to FIG. 3A, the electronic device 101 according to an embodiment may store the customized model 205. As the customized model 205 according to an embodiment is stored in the electronic device 101, an operation for searching for a similar image may be performed by the electronic device 101. Accordingly, the electronic device 101 according to an embodiment may transmit information (for example, the second feature vector 217) indicating an image generated by the customized model 205 to the server, so that an image or theme search can be quickly performed even when the network condition is poor.

The electronic device 101 according to an embodiment may generate a first feature vector 303 from the first image 301 using the customized model 205. For example, the first image 301 may include an image selected by the user through various applications of the electronic device 101 (for example, gallery application, camera application, theme store application, and Internet browser application). The electronic device 101 according to an embodiment may generate the first feature vector 303 by applying a representing type (for example, icon image, font image, or lock screen image) of at least one object (for example, icon, font, or lock screen) displayed on a display (for example, the display device 160 of FIG. 1) of the electronic device 101 as well as the first image 301, to the customized model 205. The operation in which the electronic device 101 according to an embodiment may generate the first feature vector 303 is similar to those disclosed for the second feature vector 217 in FIG. 2.

The electronic device 101 according to an embodiment may transmit the generated first feature vector 303 to the server 108, and the server 108 may determine similarity between the received first feature vector 303 and a plurality of pre-stored second feature vectors (for example, the second feature vector 217). For example, the determination of the similarity may be performed using a Euclidean distance between the first feature vector 303 and the plurality of second feature vectors (for example, the second feature vector 217) (for example, Equation (1)) or cosine similarity (for example, Equation (2)).

$$\begin{matrix}dist ( a , b ) = ‖ a - b ‖ & Equation ( 1 ) \\ sim ( a , b ) = cos θ = \frac{a \cdot b}{‖ a ‖ ‖ b ‖} & Equation ( 2 )\end{matrix}$$

In Equations (1) and (2), “a” denotes a feature vector (for example, the first feature vector 303, expressed as a vector a=[a₁ a₂ . . . a_{N}]) corresponding to the first image 301 and/or the representing type. In Equation (1), “b” denotes a feature vector (for example, the second feature vector 217 expressed as vector b=[b₁ b₂ . . . b_{N}]) corresponding to a plurality of theme packages (for example, the theme package 203) stored in the server 108. ∥a∥ and ∥b∥ denote an absolute value of the first feature vector 303 (for example, a=[a₁ a₂ . . . a_{N}]) and an absolute value of the second feature vector 217 (for example, a=[b₁ b₂ . . . b_{N}]), respectively. In order to determine similarity, the electronic device 101 according to an embodiment may repeatedly perform Equation (1) on each of the plurality of second feature vectors (for example, the second feature vector 217) stored in the server 108.

The server 108 according to an embodiment may generate recommended theme information 305 including at least one second image having high similarity on the basis of the similarity determination. For example, wallpapers or theme packages 203 having small dist(a,b) in Equation (1) and large sin(a,b) in Equation (2) may be determined to have high similarity.

The server 108 according to an embodiment may provide the generated recommended theme information 305 to the electronic device 101, and the electronic device 101 may display the recommended theme information 305 on a display (for example, the display device 160 of FIG. 1).

Referring to FIG. 3B, the customized model 205 according to an embodiment may be stored in the server 108. A description that overlaps the description of the embodiment in which the customized model 205 according to an embodiment is stored in the electronic device 101 in FIG. 3A will be omitted.

The server 108 according to an embodiment may acquire the first image 301 from the electronic device 101. For example, the server 108 may receive the first image 301 using a long-distance wireless communication network (for example, the second network 199 of FIG. 1). According to an embodiment, when acquiring the first image 301, the server 108 may also acquire, from the electronic device 101, a representing type of at least one object (for example, icon, font, or lock screen) displayed on a display (for example, the display device 160 of FIG. 1) of the electronic device 101.

The server 108 according to an embodiment may generate the first feature vector 303 from the acquired first image 301 using the customized model 205. According to an embodiment, the server 108 may generate the first feature vector 303 by applying the first image 301 and the representing type, to the customized model 205.

The server 108 according to an embodiment may determine similarity between the generated first feature vector 303 and each of the plurality of pre-stored second feature vectors (for example, the second feature vector 217). For example, the determination of the similarity may be performed using Euclidean distance (for example, Equation (1)) or cosine similarity (for example, Equation (2)).

The server 108 according to an embodiment may generate recommended theme information 305 including at least one second image having high similarity on the basis of the similarity determination. For example, wallpapers or theme packages 203 having small dist(a,b) in Equation (1) and large sim(a,b) in Equation (2) may be determined to have high similarity.

The server 108 according to an embodiment may provide the generated recommended theme information 305 to the electronic device 101. The electronic device 101 may display the provided recommended theme information 305 on a display (for example, the display device 160 of FIG. 1).

FIG. 3C is a block diagram illustrating an example of a theme information searching system 307 including an electronic device (for example, the electronic device 101 of FIG. 1) and a recommendation system 309 (for example, the server 108 of FIG. 1) according to an embodiment of the disclosure.

The theme information searching system 307 according to an embodiment may include the electronic device 101 and the recommendation system 309 (for example, the server 108 of FIG. 1).

Applications 311 according to an embodiment may include at least one of a home application, a dialer application, an SMS/MMS/Instant Message (IM) application, a browser application, a camera application, an alarm application, a contact application, a voice dial application, an email application, a calendar application, a media player application, an album application, a clock application, a health care application (for example, measurement of exercise quantity or blood sugar), or an environmental information (for example, atmospheric pressure, humidity, or temperature information) provision application. The applications 311 according to an embodiment may be driven (for example, executed) on a predetermined operating system (for example, an OS framework 313). The operating system according to various embodiments may include at least one of Android™, iOS™, Windows™, Symbian™, Tizen™, or Bada™. The OS framework 313 according to an embodiment may be a set of services making an environment in which at least one application 311 can be operated and managed.

The operating system (for example, the OS framework) according to an embodiment may include a control module 315. The control module 315 according to an embodiment may be a content provision module that provides a data transmission/reception function between a plurality of applications. The control module 315 according to an embodiment may provide recommended theme information from a theme store client 317 to the applications 311. The control module 315 according to an embodiment may provide at least one image from the applications 311 to the theme store client 317. The control module 315 according to an embodiment may control the theme store client 317 to provide a feature vector or at least one image to the recommendation system 309 through at least one communication circuit (for example, a communication processor).

The theme store client 317 according to an embodiment may include at least one hardware and/or software module implemented as an application. The theme store client 317 according to an embodiment may include, for example, a theme store application. The theme store client 317 according to an embodiment may provide recommended theme information (for example, a theme package) to the applications 311 through the operating system. The theme store client 317 according to an embodiment may be connected to the recommendation system via a communication circuit through wireless communication or wired communication. The theme store client 317 according to an embodiment may be associated (or connected) with the customized model 205 stored in the electronic device 101 (for example, the memory 130) so that the theme store client 317 can access the customized model 205 or vice versa. The theme store client 317 according to an embodiment may generate a feature vector (for example, the first feature vector 303 of FIG. 3A) from an image (for example, the first image 301) through the customized model 205 included in the theme store client 317 and transmit the generated feature vector to the recommendation system 309. The function or the operation for transmitting the feature vector to the recommendation system 309 according to an embodiment may be controlled by the control module 315.

The recommendation system 309 according to an embodiment may include at least one recommendation server. The recommendation system 309 according to an embodiment may be connected to the electronic device 101 through wireless communication or wired communication. The recommendation system 309 according to an embodiment may store at least some pieces of recommended theme information. The recommendation system 309 according to an embodiment may transmit at least some pieces of recommended theme information stored in the recommendation system 309 to the electronic device 101 (for example, the theme store client 317). The recommendation system 309 according to an embodiment may determine similarity between the first feature vector 303 received from the electronic device 101 and a plurality of second feature vectors (for example, the second feature vector 217 of FIG. 2). The recommendation system 309 according to an embodiment may transmit recommended theme information (for example, the recommended theme information 305 of FIG. 3A or 3B) including at least one image having a value larger than or equal to a predetermined threshold similarity value.

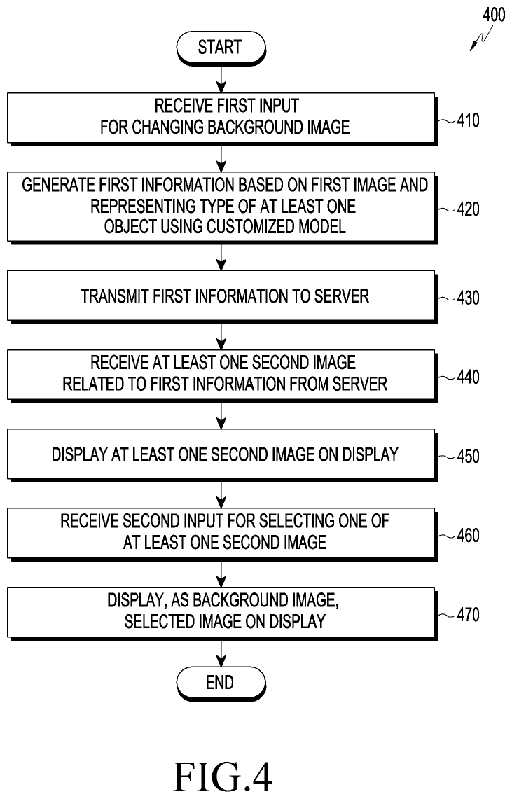

FIG. 4 is a flow chart 400 illustrating an operation in which an electronic device (for example, the electronic device 101 of FIG. 1) receives at least one second image related to a first image (for example, the first image 301 of FIG. 3A or FIG. 3B) using a customized model (for example, the customized model 205 of FIG. 2) according to an embodiment of the disclosure.

The electronic device 101 (for example, the processor 120 of FIG. 1) according to an embodiment may receive a first input for changing a background image in operation 410. The first input according to an embodiment may include a touch input (for example, a long touch input) on the background image or an input for selecting a predetermined icon (for example, a camera application icon) for acquiring an image. The processor 120 may include a microprocessor or any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), a Graphical Processing Unit (GPU), a video card controller, etc. In addition, it would be recognized that when a general purpose computer accesses code for implementing the processing shown herein, the execution of the code transforms the general purpose computer into a special purpose computer for executing the processing shown herein. Certain of the functions and steps provided in the Figures may be implemented in hardware, software or a combination of both and may be performed in whole or in part within the programmed instructions of a computer. No claim element herein is to be construed under the provisions of 35 U.S.C. § 112(f), unless the element is expressly recited using the phrase “means for.” In addition, an artisan understands and appreciates that a “processor” or “microprocessor” may be hardware in the claimed disclosure. Under the broadest reasonable interpretation, the appended claims are statutory subject matter in compliance with 35 U.S.C. § 101.

The electronic device 101 according to an embodiment may generate first information (for example, the first feature vector 303 of FIG. 3A or 3B) based on the first image and a representing type of at least one object using the customized model 205 in operation 420. The representing type according to an embodiment may include configuration information of at least one object displayed on a display (for example, the display device 160) of the electronic device 101. According to an embodiment, at least one object may include at least one of icon, font, or lock screen displayed on the display (for example, the display device 160) of the electronic device 101. According to an embodiment, when at least one object is an icon, the representing type may include at least one of the shape or the color of the icon. Thus, in another embodiment, the representing type may be referred to as representative information of the at least one object. According to an embodiment, when at least one object is a font, the representing type may include the letter style (e.g. italic type) or the letter thickness of the font. According to an embodiment, when at least one object is a lock screen, the representing type may include the lock screen image. According to an embodiment, when the customized model 205 is stored in a server (for example, the server 108 of FIG. 1), operation 420 may be performed by the server 108.

The electronic device 101 according to an embodiment may transmit first information (for example, the first feature vector 303 of FIG. 3A or 3B) to the server 108 in operation 430. For example, the electronic device 101 may transmit the generated first feature vector 303 to the server 108 through a long-distance wireless communication network (for example, the second network 199 of FIG. 1). According to an embodiment, when operation 420 is performed by the server 108, operation 430 may be omitted.

The electronic device 101 according to an embodiment may receive at least one second image related to the first information (for example, the first feature vector 303 of FIG. 3A or 3B) from the server 108 in operation 440. For example, the electronic device 101 may receive recommended theme information (for example, the recommended theme information 305 of FIG. 3A or 3B) including at least one second image (for example, wallpaper or theme package 203) corresponding to a second feature vector having the highest similarity with the first feature vector 303 among a plurality of second feature vectors (for example, the second feature vector 217 of FIG. 2) pre-stored in the server 108. In the instant disclosure, the reception of the second image may include reception of information related the second image (for example, a thumbnail image of the second image).

The electronic device 101 according to an embodiment may display at least one second image on a display (for example, the display device 160 of FIG. 1) in operation 450. For example, the electronic device 101 may display the received recommended theme information 305 on the display (for example, the display device 160). According to an embodiment, at least one second image may correspond to a background or wallpaper image or a theme package (for example, a package including a wallpaper image, an icon image, a lock screen image, or a font image). The at least one second image according to an embodiment may be displayed as a thumbnail image on the display (for example, the display device 160).

The electronic device 101 according to an embodiment may receive a second input for selecting one of the at least one second image in operation 460.

The electronic device 101 according to an embodiment may display the selected second image as the background image on the display (for example, the display device 160) in operation 470. For example, the electronic device 101 may configure a wallpaper image corresponding to the selected second image as a background image. According to an embodiment, when the selected second image corresponds to a theme package, the electronic device 101 may apply the wallpaper image and at least one of the icon image, the lock screen image, or the font image included in the theme package to the electronic device 101.

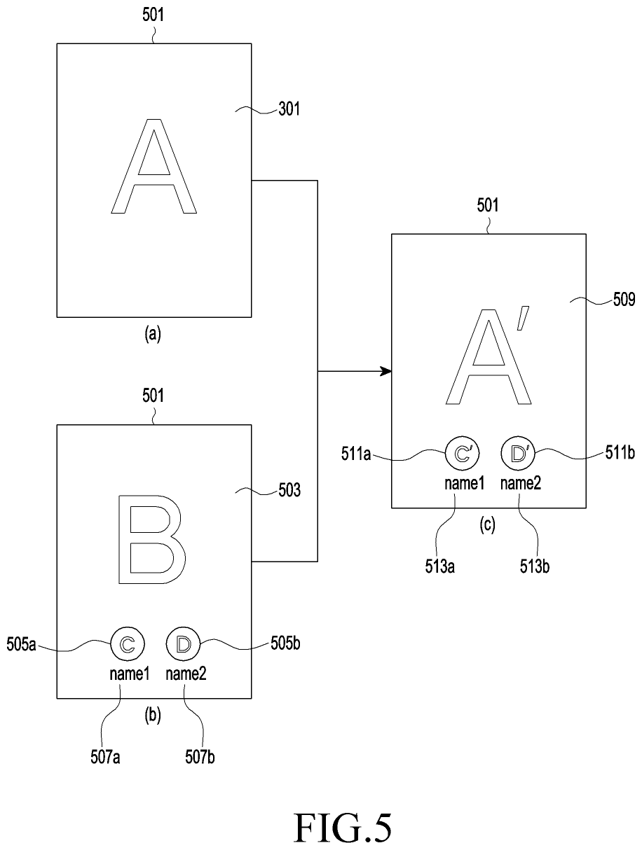

FIG. 5 are views illustrating an example of a second image 509 (or a theme package) related to the first image 301 according to an embodiment.

Referring to FIG. 5, as shown in screen (a), the first image 301 may be an image displayed on a display 501 of the electronic device 101 and selected by the user. For illustration purposes, the first image 301 is shown as“A.”

Referring to screen (b) in FIG. 5, a wallpaper image 503, at least one icon (for example, icons 505a and 505b), and at least one font (for example, fonts 507a and 507b) are illustrated as a theme package applied to the electronic device 101. Although the at least one font (for example, the fonts 507a and 507b) according to an embodiment are shown as icon name texts (name 1 and name 2) corresponding to the at least one icon (for example, the icons 505a and 505b) by way of example, the at least one font is not so limited and may include fonts applied to various menus of the electronic device 101.

Referring to screen (c) in FIG. 5, as the electronic device 101 performs operations 410 to 440 of FIG. 4, an embodiment of applying one image selected from at least one second image as a background image 509 is illustrated. According to an embodiment, when the first image 301 is a photo of a gray cat looking forward, as illustrated in the later drawings, the background image 509 may include a gray cat image or an image of a cat looking forward.

Referring to screen (c) in FIG. 5, when one image selected from the at least one second image similar to the selected first image 301 corresponds to the theme package, at least one icon image (for example, icon images 511a and 511b) or at least one font image (for example, font images 513a and 513b) may be similar to at least one icon image (for example, the icon images 505a and 505b) or at least one font image (for example, the font images 507a and 507b) previously displayed at the display 501 of the electronic device 101 as illustrated in screen (b) of FIG. 5. For example, when at least one icon image (for example, the icon images 505a and 505b) is an icon image in a triangular shape (not shown in FIG. 5), at least one icon image (for example, the icon images 511a and 511b) may include an icon image in a triangular shape rotated at a predetermined angle. According to an embodiment, when at least one font image (for example, the font images 507a and 507b) is a predetermined letter style (for example, “Times New Roman”), at least one font image 513a and 513b may be “Times New Roman” or a letter style similar thereto (for example, “Arial”). According to an embodiment, a letter style similar to a predetermined letter style may be pre-stored in the electronic device 101 or the server 108.

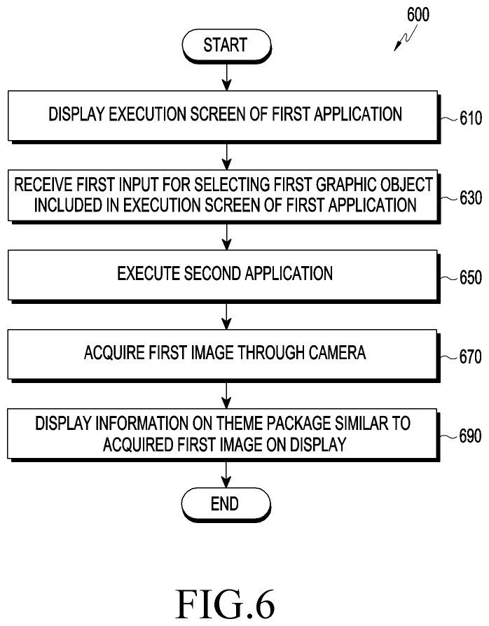

FIG. 6 is a flow chart 600 illustrating an operation in which an electronic device (for example, the electronic device 101 of FIG. 1) according to an embodiment acquires a first image (for example, the first image 301 of FIG. 3A or 3B) for changing a background image through a camera (for example, the camera module 180 of FIG. 1).

The electronic device 101 according to an embodiment may display an execution screen of a first application in operation 610. For example, the first application may include a theme store application (for example, SAMSUNG THEMES application) for searching for a background image or a theme image or package.

The electronic device 101 according to an embodiment may receive a first input for selecting a first graphic object included in the execution screen of the first application in operation 630. For example, the first graphic object may include an icon for executing a second application (for example, a camera application).

The electronic device 101 according to an embodiment may execute the second application in operation 650. The electronic device 101 may execute the second application (for example, the camera application) in response to reception of the first input for selecting the first graphic object.

The electronic device 101 according to an embodiment may acquire the first image 301 through a camera (for example, the camera module 180) in operation 670. For example, the electronic device 101 may acquire the first image 301 through the camera (for example, the camera module 180) using the second application (for example, the camera application).

The electronic device 101 according to an embodiment may display information on a theme package similar to the first image acquired in operation 670 on a display (for example, the display device 160 of FIG. 1) in operation 690. The same description of operations 420 to 450 may be applied to operation 690 according to an embodiment of the disclosure.

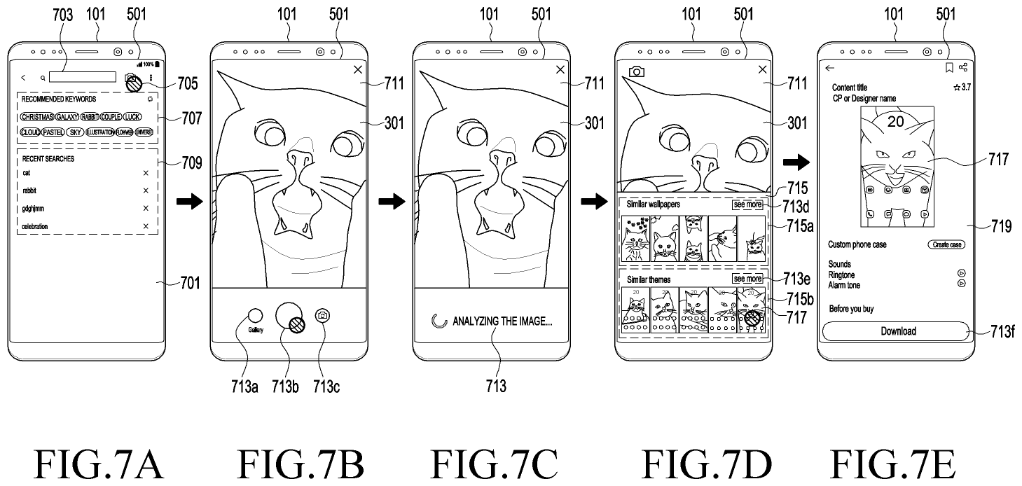

FIG. 7A is a view illustrating an example of an operation in which an electronic device (for example, the electronic device 101 of FIG. 1) according to an embodiment receives at least one second image using a first image (for example, the first image 301 of FIG. 3A or 3B) acquired through a camera (for example, the camera module 180 of FIG. 1). FIG. 7B is a view illustrating an example of an operation in which an electronic device (for example, the electronic device 101 of FIG. 1) according to an embodiment receives at least one second image using a first image (for example, the first image 301 of FIG. 3A or 3B) acquired through a camera (for example, the camera module 180 of FIG. 1). FIG. 7C is a view illustrating an example of an operation in which an electronic device (for example, the electronic device 101 of FIG. 1) according to an embodiment receives at least one second image using a first image (for example, the first image 301 of FIG. 3A or 3B) acquired through a camera (for example, the camera module 180 of FIG. 1). FIG. 7D is a view illustrating an example of an operation in which an electronic device (for example, the electronic device 101 of FIG. 1) according to an embodiment receives at least one second image using a first image (for example, the first image 301 of FIG. 3A or 3B) acquired through a camera (for example, the camera module 180 of FIG. 1). FIG. 7E is a view illustrating an example of an operation in which an electronic device (for example, the electronic device 101 of FIG. 1) according to an embodiment receives at least one second image using a first image (for example, the first image 301 of FIG. 3A or 3B) acquired through a camera (for example, the camera module 180 of FIG. 1).

Referring to FIG. 7A, the electronic device 101 according to an embodiment may display an execution screen 701 of a first application (for example, the theme store client 317) on the display 501 (for example, the display device 160 of FIG. 1). The execution screen 701 of the first application may include at least one of a search keyword input area 703, a first graphic object 705, a recommended keyword list 707, or a recent search history list 709. According to an embodiment, the electronic device 101 may receive a search keyword (for example, a character string “cat”) through the search keyword input area 703 in order to search for at least one background image or at least one theme image corresponding to the keyword. The first graphic object 705 according to an embodiment may be an icon image for executing the second application (for example, the camera application). After receiving at least one similar second image using the first image 301 described below, the electronic device 101 according to an embodiment may select an image corresponding to the search keyword from the at least one second image on the basis of the search keyword inputted into the search keyword input area 703.

Referring to FIG. 7B, when receiving the first input (for example, a touch input) for selecting the first graphic object 705 from the user, the electronic device 101 according to an embodiment may display an execution screen 711 of the second application (for example, the camera application) on the display 501. The execution screen 711 of the second application (for example, the camera application) according to an embodiment may include a first area (e.g. viewfinder area) including a currently captured image (for example, the first image 301) and a second area including at least one graphic object (for example, second graphic object 713a, third graphic object 713b, or fourth graphic object 713c) as illustrated in FIG. 7B. The second graphic object 713a according to an embodiment may be an icon image for executing a gallery application. The third graphic object 713b according to an embodiment may be an image for capturing an image being currently displayed through the viewfinder (for example, the first image 301) using the camera (for example, the camera module 180). The fourth graphic object 713c according to an embodiment may be an icon image for switching the camera application to a selfie mode.

Referring to FIG. 7C, when receiving an input (for example, a touch input) for selecting the third graphic object 713b from the user, the electronic device 101 according to an embodiment may provide the first image 301 to the first application (for example, the theme store client 317 of FIG. 3C) through the OS framework (for example, the OS framework 313 of FIG. 3C). Accordingly, the electronic device 101 may provide the captured image (for example, the first image 301) to the theme store client 317 without terminating the second application (for example, the camera application). According to an embodiment, the electronic device 101 may generate a first feature vector (for example, the first feature vector 303 of FIG. 3A or 3B) based on the captured first image 301 using the customized model 205 and transmit the generated first feature vector 303 to the server 108. The electronic device 101 according to an embodiment may receive recommended theme information (for example, the recommended theme information 305 of FIG. 3A or 3B) on the basis of the first feature vector 303 transmitted from the server 108. The electronic device 101 according to an embodiment may display a notification message 713 (for example, “analyzing the image”) indicating that the first image 301 is being analyzed on the display 501 while the electronic device 101 generates the first feature vector 303, transmits the same to the server 108, and receives the recommended theme information 305 from the server 108. When the first feature vector 303 is generated, the electronic device 101 according to an embodiment may generate the first feature vector 303 on the basis of the captured first image 301 and a representing type of at least one object (e.g. configuration information of a theme package not shown in FIGS. 7A-7E). According to an embodiment, the first feature vector 303 may be generated by the server 108.

Referring to FIG. 7D, the electronic device 101 according to an embodiment may display a search result list 715 in at least a partial area of the display 501 displaying the received recommended theme information 305. For example, the electronic device 101 according to an embodiment may display the received recommended theme information 305 in the form of the search result list 715 in at least a partial area of the execution screen of the first application through the control module 315. For example, the search result list 715 may include a similar background image list (for example, a similar wallpaper image list 715a) and a similar theme image list (for example, a similar theme package list 715b). Although FIG. 7D illustrates that five images are listed in each of the similar background image list 715a and the similar theme image list 715b, this is only an example. Accordingly, the electronic device 101 may provide the recommended theme information 305 acquired through the first application (for example, theme store client 317) without terminating the second application (for example, the camera application). According to an embodiment, when receiving an input for selecting a fifth graphic object (for example, “see more”) 713d or a sixth graphic object (for example, “see more”) 713e, the electronic device 101 may further display a plurality of images (for example, similar background images or similar theme images) based on the recommended theme information 305 which is not illustrated in FIG. 7D.

Referring to FIG. 7E, when one image (for example, a third image 717 of FIG. 7D) is selected from at least one similar theme image list 715b, the electronic device 101 according to an embodiment may display detailed information 719 on the one selected image (for example, the third image 717) on the display 501. For example, the detailed information 719 may include various pieces of information such as a title, a content provider (CP), or a designer of the one selected image (for example, the third image 717), or a sound (for example, a ringtone, a notification sound, or an alarm tone) included in the theme package. When receiving an input (for example, a touch input) for selecting a seventh graphic object 713f included in an area in which the detailed information 719 is displayed, the electronic device 101 may receive a theme package (or a background image) corresponding to the one selected image (for example, the third image 727) from the server 108. For example, the theme package may include at least one of an icon image, a wallpaper image (in other words, a background image), a lock screen image, a font image, or label information.

As described above, it is possible to perform a quick and seamless operation of receiving and displaying the recommended theme information 305 similar to the first image 301 acquired through the second application (for example, the camera application) in the execution screen 711 of the second application without terminating the second application.

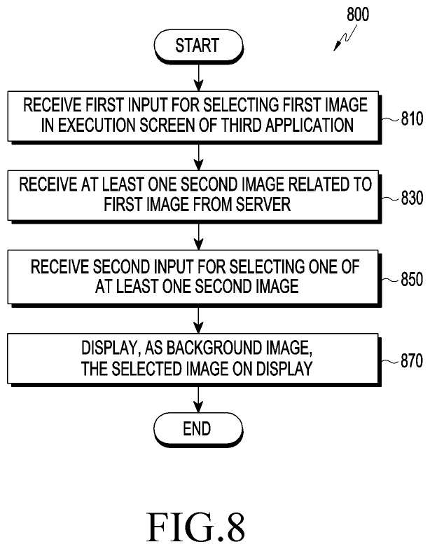

FIG. 8 is a flow chart illustrating an operation in which an electronic device (for example, the electronic device 101 of FIG. 1) according to an embodiment receives at least one second image through a third application.

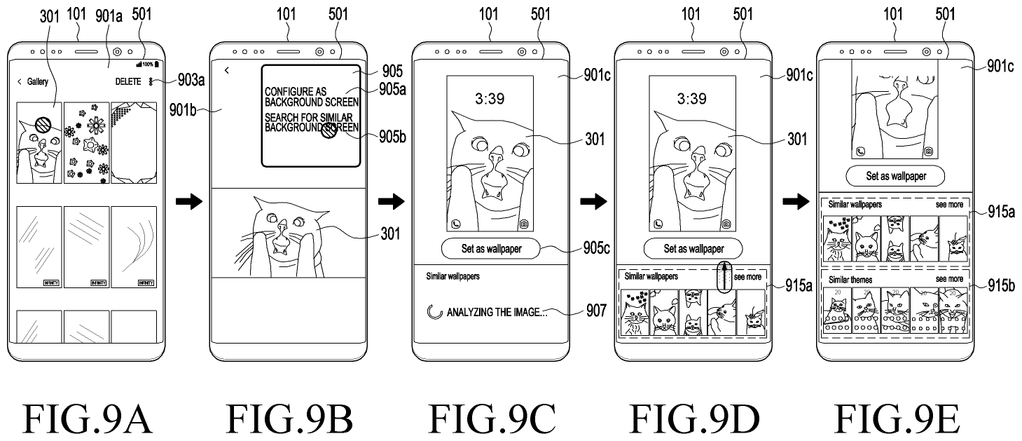

FIG. 9A is a view illustrating an operation in which an electronic device (for example, the electronic device 101 of FIG. 1) according to an embodiment receives at least one second image through a third application (for example, a gallery application). FIG. 9B is a view illustrating an operation in which an electronic device (for example, the electronic device 101 of FIG. 1) according to an embodiment receives at least one second image through a third application (for example, a gallery application). FIG. 9C is a view illustrating an operation in which an electronic device (for example, the electronic device 101 of FIG. 1) according to an embodiment receives at least one second image through a third application (for example, a gallery application). FIG. 9D is a view illustrating an operation in which an electronic device (for example, the electronic device 101 of FIG. 1) according to an embodiment receives at least one second image through a third application (for example, a gallery application). FIG. 9E is a view illustrating an operation in which an electronic device (for example, the electronic device 101 of FIG. 1) according to an embodiment receives at least one second image through a third application (for example, a gallery application)

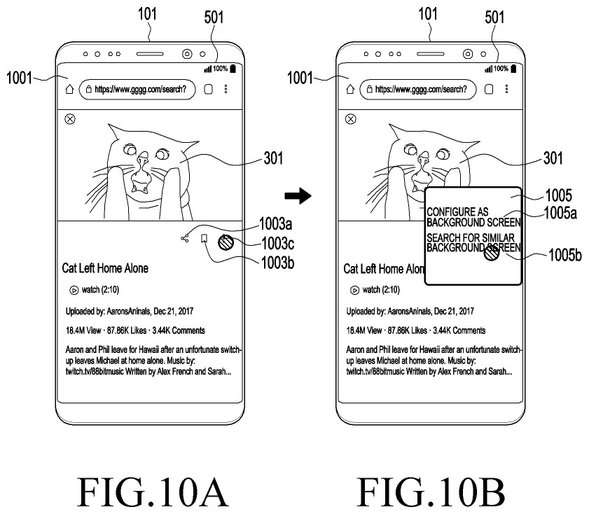

FIG. 10A is a view illustrating an operation in which an electronic device (for example, the electronic device 101 of FIG. 1) according to an embodiment receives at least one second image through a third application (for example, an Internet application). FIG. 10B is a view illustrating an operation in which an electronic device (for example, the electronic device 101 of FIG. 1) according to an embodiment receives at least one second image through a third application (for example, an Internet application).

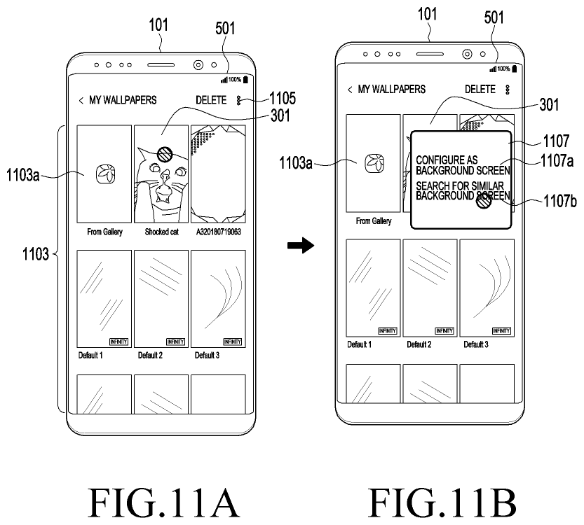

FIG. 11A is a view illustrating an operation in which an electronic device (for example, the electronic device 101 of FIG. 1) according to an embodiment receives at least one second image through a third application (for example, a theme store application). FIG. 11B is a view illustrating an operation in which an electronic device (for example, the electronic device 101 of FIG. 1) according to an embodiment receives at least one second image through a third application (for example, a theme store application)

Referring to a flowchart 800 of FIG. 8, the electronic device 101 according to an embodiment may receive a first input for selecting a first image in an execution screen of a third application in operation 810. For example, the third application may include various applications for searching for an image such as a gallery application, an Internet application, or a theme store application.

The electronic device 101 according to an embodiment may receive at least one second image related to a first image (for example, the first image 301 of FIG. 3A or 3B) from a server (for example, the server 108 of FIG. 1) in operation 830. The same description of operation 830 may be applied to operation 440 of FIG. 4.

The electronic device 101 according to an embodiment may receive a second input for selecting one of at least one second image in operation 850. The same description of operation 850 may be applied to operation 460 of FIG. 4.

The electronic device 101 according to an embodiment may display, as a background image, the one selected image on a display (for example, the display 501 of FIG. 5) in operation 870. In other words, the electronic device 101 may configure the one selected image as a background image. The same description of operation 870 may be applied to operation 470 of FIG. 4.

FIGS. 9A-9E illustrates an example in which the third application of FIG. 8 is a gallery application.

Referring to FIG. 9A, the electronic device 101 according to an embodiment may display a first execution screen 901a of the gallery application on the display 501. According to an embodiment, the first execution screen 901a of the gallery application may include one or more images (for example, the first image 301) stored in a memory (for example, the memory 130 of FIG. 1) of the electronic device 101 and an eighth graphic object 903a.

The electronic device 101 according to an embodiment may receive a first input for selecting the first image 301 among the one or more images. For example, the first input may include a touch input (for example, a long touch input) for the first image 301 or a touch input for selecting the eighth object 903a.

Referring to FIG. 9B, the electronic device 101 according to an embodiment may display a second execution screen 901b of the gallery application on the display 501 after receiving the first input that includes a first setting menu 905. The first setting menu 905 according to an embodiment may include a first item 905a for configuring the selected image (for example, the first image 301) as the background image and a second item 905b for searching for a background image similar to the selected image (for example, the first image 301). According to another embodiment, the second item 905b may be an item for searching for a similar theme image or package.

Referring to FIG. 9C, when receiving an input (for example, a touch input) for selecting the second item 905b, the electronic device 101 according to an embodiment may display a third execution screen 901c of the gallery application (or an execution screen of a background screen setting application) and search for a background image similar to the selected image (for example, the first image 301). The electronic device 101 may display a second notification message 907 indicating “analyzing the image” in an area 909 of the third execution screen 901c while a similar background image is searched for. The electronic device 101 according to an embodiment may display a preview image showing if the selected image (for example, the first image 301) is configured as the background screen in a first area of the third execution screen 901c. For example, the first image 301 displayed as the preview image may include various icons including a clock icon. The electronic device 101 may include a ninth graphic object 905c for configuring the selected image (for example, the first image 301) as the background screen.

Referring to FIG. 9D, when the search for the similar background image is completed, the electronic device 101 according to an embodiment may display a search result list (for example, the recommended theme information 305 of FIG. 3A or 3B) in the first area of the third execution screen 901c. A similar background image list 915a may be displayed in the first area of the third execution screen 901c. When an input (for example, a touch input) for selecting one background image from the similar background image list 915a is received, the electronic device 101 according to an embodiment may display detailed information on the one selected background image as illustrated in FIG. 7E.

Referring to FIG. 9E, when a drag (in other words, touch-drag) input in an up direction is received after the first area in which the similar background image list 915a is displayed is touched, the electronic device 101 according to an embodiment may further display a similar theme image list 915b in the first area. When an input (for example, a touch input) for selecting one theme image from the similar theme image list 915b is received, the electronic device 101 according to an embodiment may display detailed information on the one selected theme image as illustrated in FIG. 7E.

FIGS. 10A-10B illustrate an example of describing the case in which the third application of FIG. 8 is an Internet application.

Referring to FIG. 10A, the electronic device 101 according to an embodiment may display a first execution screen 1001 of an Internet application on the display 501. The first execution screen 1001 of the Internet application may include an image (for example, the first image 301) found using the Internet application, detailed information on the found image (for example, the first image 301), and at least one graphic object (for example, a tenth graphic object 1003a, a eleventh graphic object 1003b, or a twelfth graphic object 1003c). For example, the tenth graphic object 1003a may be a graphic object for sharing the found image (for example, the first image 301) with an external electronic device. The eleventh graphic object 1003b may be a graphic object for storing (bookmarking) detailed information on the found image (for example, the first image 301). The twelfth graphic object 1003c may be a graphic object for displaying a setting menu (for example, the second setting menu 1005 of FIG. 10B) for configuring the found image (for example, the first image 301) as the background image.

Referring to FIG. 10B, when an input (for example, a touch input) for selecting the twelfth graphic object 1003c is received, the electronic device 101 according to an embodiment may display the second setting menu 1005 on the first execution screen 1001 of the Internet application. For example, the second setting menu 1005 may include at least one of a third item 1005a for configuring the found image (for example, the first image 301) as the background image or a fourth item 1005b for searching for a background image similar to the found image (for example, the first image 301). According to an embodiment, the fourth item 1005b may be an item for searching for a theme image or package similar to the found image (for example, the first image 301). When an input (for example, a touch input) for selecting the fourth item 1005b is received, the electronic device 101 according to an embodiment may display a second execution screen (not shown) of the Internet application (or an execution screen of a background screen setting application) and search for a background image similar to the found image (for example, the first image 301). The subsequent operations of the electronic device in FIGS. 10A-10B may be the same as the operations of FIGS. 9C to 9E.

FIGS. 11A-11B illustrates an example in which the third application of FIG. 8 is a theme store application (for example, SAMSUNG THEMES application) according to an embodiment.

Referring to FIG. 11A, the electronic device 101 according to an embodiment may display a first execution screen 1101 of the theme store application on the display 501. The first execution screen 1101 of the theme store application may include at least one background image which a user of the theme store application has downloaded in advance, a download history 1103 of at least one theme image or package, and a thirteenth graphic object 1105. According to an embodiment, the download history 1103 may further include a fourteenth graphic object 1103a for executing the gallery application.

Referring to FIG. 11B, when an input for selecting the first image 301 in the downlink history 1103 is received, the electronic device 101 according to an embodiment may display a third setting menu 1107 on a first execution screen 1101a of the theme store application. For example, the input for selecting the first image 301 may include an input of touching a fourteenth graphic object 1103a after a touch (for example, a long touch) is performed on the first image 301. For example, the third setting menu 1107 may include at least one of a fifth item 1107a for configuring the selected image (for example, the first image 301) as a background image or a sixth item 1107b for searching for a background image similar to the selected image (for example, the first image 301). According to an embodiment, the sixth item 1107b may be an item for searching for a similar theme image or package.

When an input (for example, a touch input) for selecting the sixth item 1107b is received, the electronic device 101 according to an embodiment may display a second execution screen (not shown) of the theme store application (for example, an execution screen of a background screen setting application) and search for a background image or theme image similar to the selected image (for example, the first image 301). The subsequent operation of the electronic device may be the same as the operations of FIGS. 9C to 9E. When the selected first image corresponds to a specific theme package, the electronic device 101 according to an embodiment may search for a similar theme image by applying, to the customized model 205, the first image and theme elements (for example, an icon, a font, and a lock screen) included in the specific theme package corresponding to the selected first image instead of theme elements of the electronic device 101 (for example, an icon, a font, and a lock screen).

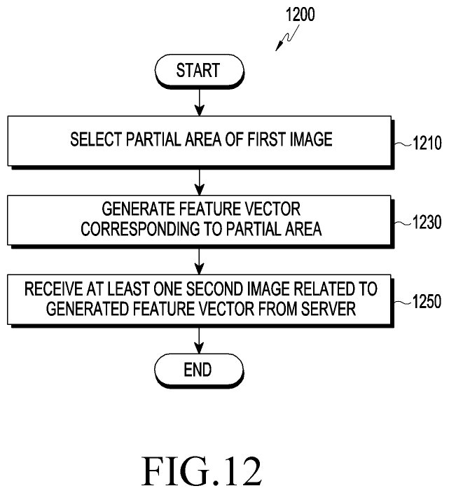

FIG. 12 is a flow chart illustrating an example in which an electronic device (for example, the electronic device 101 of FIG. 1) according to an embodiment receives at least one second image on the basis of a partial area of a first image.

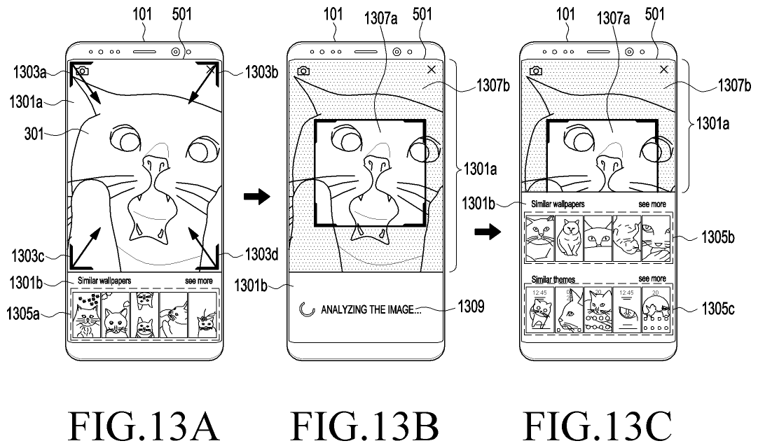

FIG. 13A is a view illustrating an example in which an electronic device (for example, the electronic device 101 of FIG. 1) according to an embodiment receives at least one second image on the basis of a partial area of a first image. FIG. 13B is a view illustrating an example in which an electronic device (for example, the electronic device 101 of FIG. 1) according to an embodiment receives at least one second image on the basis of a partial area of a first image. FIG. 13C is a view illustrating an example in which an electronic device (for example, the electronic device 101 of FIG. 1) according to an embodiment receives at least one second image on the basis of a partial area of a first image.

Referring to a flowchart 1200 of FIG. 12, the electronic device 101 according to an embodiment may select a partial area of a first image (for example, the first image 301 of FIG. 3A or 3B) in operation 1210.

The electronic device 101 according to an embodiment may generate a feature vector corresponding to the partial area in operation 1230. For example, the electronic device 101 may input the selected partial image of the first image 301 into a customized model (for example, the customized model 205 of FIG. 2) so as to generate a feature vector (for example, the second feature vector 217 of FIG. 2) based on a partial image.

The electronic device 101 according to an embodiment may receive at least one second image related to the feature vector generated by the server (for example, the server 108 of FIG. 1) in operation 1250. For example, at least one second image may correspond to a feature vector having high similarity with the generated feature vector. More specifically, the feature vector corresponding to at least one second image may include a feature vector having a small Euclidean distance result value or a large cosine similarity result value with the generated feature vector.

FIGS. 13A to 13C illustrate an example of the operations of FIG. 12 according to an embodiment.

Referring to FIG. 13A, the electronic device 101 according to an embodiment may display, as an entire screen, an execution of a third application on the display 501. The electronic device 101 may display the first image 301 in a first area 1301a of the execution screen of the third application (for example, a camera application, an Internet browser application, a theme store application, or a background image setting application) and display a first search result 1305a of a background image similar to the first image 301 in a second area 1301b of the execution screen of the third application.

According to an embodiment, a plurality of indicators 1303a, 1303b, 1303c, and 1303d may be displayed in the first area 1301a in which the first image 301 is displayed. The electronic device 101 may receive a drag input for at least one of the plurality of indicators 1303a, 1303b, 1303c, and 1303d.

Referring to FIG. 13B, when each of the plurality of indicators 1303a, 1303b, 1303c, and 1303d is dragged in a central direction of the first area 1301a according to an embodiment, a first partial area 1307a of the first image 301 may be selected. A second partial area 1307b of the first image 301 which is not selected may be displayed as being greyed out. The electronic device 101 may search for at least one background image or at least one theme image or package similar to the selected first partial area 1307a. The electronic device 101 may display a third notification message 1309 (for example, “analyzing the image”) indicating that at least one background image or theme image is being searched for in the second area 1301b.

Referring to FIG. 13C, the electronic device 101 according to an embodiment may display a second search result 1305b of the background image similar to the selected first partial area 1307a and a third search result 1305c of at least one theme image in the second area 1301b. For example, at least one background image included in the second search result 1305b may be different from at least some of at least one background image included in the first search result 1305a.

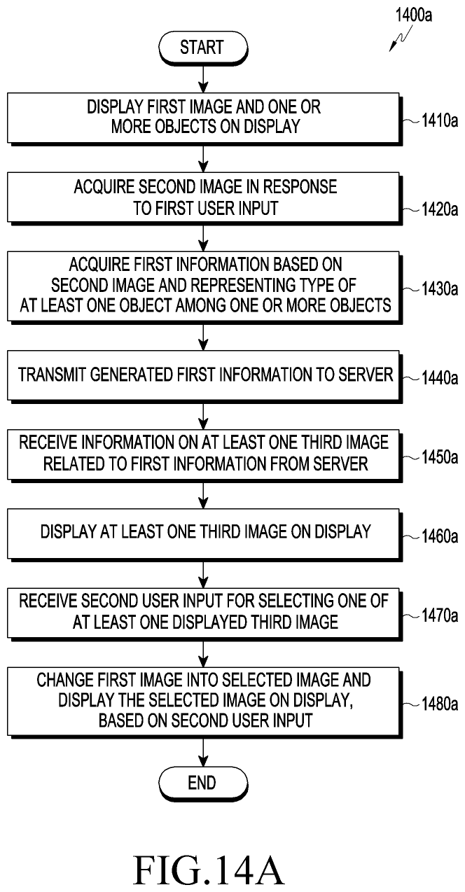

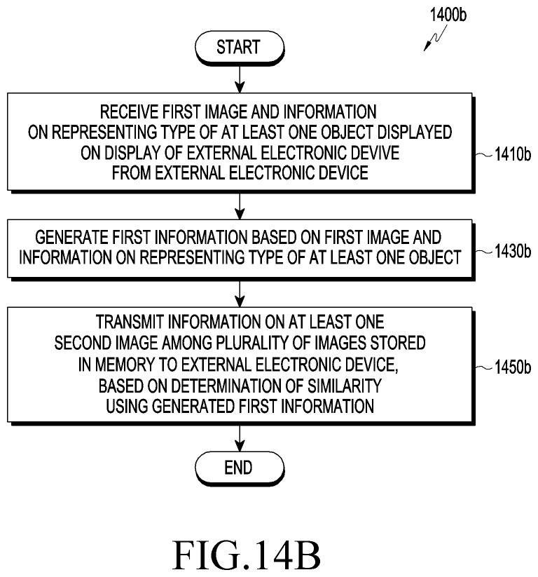

FIG. 14A is a flow chart 1400a illustrating an operation in which an electronic device (for example, the electronic device 101 of FIG. 1) according to an embodiment receives recommended theme information (for example, information on at least one third image) similar to a second image.

Referring to FIG. 14A, the electronic device 101 according to an embodiment may display the first image and one or more objects on a display (for example, the display device 160 of FIG. 1) in operation 1410a. For example, the first image may be an initial background image of the electronic device 101. For example, the one or more objects may be an initial icon, an initial letter, or an initial lock screen.

The electronic device 101 according to an embodiment may acquire a second image in response to a first user input in operation 1420a. For example, the second image may be an image captured by a camera, an image stored in a memory of the electronic device 101, an image searched via an internet application, or an image previously downloaded via a theme store application.

The electronic device 101 according to an embodiment may acquire first information based on the second image and a representing type of at least one of the one or more objects in operation 1430a.

The electronic device 101 according to an embodiment may transmit the generated first information to a server in operation 1440a.

The electronic device 101 according to an embodiment may receive information on at least one third image related to the first information from the server in operation 1450a.

The electronic device 101 according to an embodiment may display at least one third image on the display in operation 1460a.

The electronic device 101 according to an embodiment may receive a second user input for selecting one of the at least one displayed third image in operation 1470a.

The electronic device 101 according to an embodiment may change the first image to the one selected image on the basis of a second user input and display the one selected image on the display in operation 1480a.

FIG. 14B is a flow chart 1400b illustrating an operation in which an electronic device (for example, the server 108 of FIG. 1) according to an embodiment transmits recommended theme information (for example, information on at least one second image) similar to the first image to an external electronic device.

Referring to FIG. 14B, an electronic device (for example, the server 108) according to an embodiment may receive the first image and information on a representing type of at least one object displayed on a display (for example, the display device 160 of FIG. 1) of an external electronic device (for example, the electronic device 101) from the external electronic device (for example, the electronic device 101 of FIG. 1).

The electronic device (for example, the server 108) according to an embodiment may generate first information based on the first image and information on the representing type if at least one object in operation 1430b.

The electronic device (for example, 108) according to an embodiment may transmit information on at least one second image among a plurality of images stored in a memory to the external electronic device (for example, the electronic device 101) on the basis of similarity determination using the generated first information in operation 1450b.

An electronic device (for example, the electronic device 101 of FIG. 1) according to an embodiment may include a display (for example, the display device 160 of FIG. 1 or the display 501 of FIG. 5), a memory (for example, the memory 130 of FIG. 1), and at least one processor (for example, the processor 120 of FIG. 1), wherein the at least one processor is configured to display a first image (for example, the wallpaper image 503 of FIG. 5) and one or more objects (for example, at least one icon 505a and 505b or at least one font 507a and 507b) on the display, acquire a second image (for example, the first image 301 of FIG. 3A or 3B) in response to a first user input, acquire first information (for example, the first feature vector 303 of FIG. 3A) based on the second image and a representing type of at least one of the one or more objects (for example, at least one icon 505a and 505b or at least one font 507a and 507b of FIG. 5), transmit the acquired first information to a server (for example, the server 108 of FIG. 1), receive information (for example, the recommended theme information 305 of FIG. 3A or 3B) on at least one third image related to the first information from the server, display the information on the at least one third image on the display, receive a second user input for selecting the at least one third image, and change the first image into the one at least one third image and displaying the at least one third image on the display on the basis of the second user input.

The electronic device (for example, the electronic device 101 of FIG. 1) according to an embodiment may further include a camera (for example, the camera module 180 of FIG. 1), and the at least one processor may be further configured to display an execution screen (for example, the execution screen 701 of FIG. 7) of a first application for searching for a recommended image, the execution screen of the first application comprising a first graphic object (for example, the first graphic object 705 of FIG. 7) corresponding to a second application (for example, a camera application), receive a third user input for selecting the first graphic object, execute the second application in response to the third user input, and acquire the second image (for example, the first image 301 of FIG. 3A or 3B) through the camera using the second application.

The first information (for example, the first feature vector 303 of FIG. 3A) according to an embodiment may include a first feature vector (for example, the first feature vector 303 of FIG. 1) generated based on the second image and the representing type.

The first feature vector according to an embodiment may be generated based on a partial area (for example, the first partial area 1307a of FIG. 13) of the second image.

The first feature vector according to an embodiment may be generated by combining first output data corresponding to the second image and second output data corresponding to the representing type of the at least one object.

The at least one third image according to an embodiment may be found based on a determination of similarity between the first feature vector and feature vectors corresponding to a plurality of images stored in the server.

The determination of the similarity according to an embodiment may be based on a Euclidean distance or cosine similarity between the first feature vector and feature vectors corresponding to the plurality of images.

The electronic device (for example, the electronic device 101 of FIG. 1) according to an embodiment may further include a customized model (for example, the customized model 205 of FIG. 2), the customized model may be generated through machine learning using at least one of a plurality of background images stored in the server, a plurality of lock screen images, a plurality of icon images, a plurality of font images, or label information for a pre-learned model (for example, the CNN models 211-1 to 211-n or DNN models 213-1 to 213-m of FIG. 2) stored in the server, and the processor may be configured to generate the first information on the basis of the second image and the representing type using the customized model.

The one or more objects according to an embodiment may include at least one of one or more icons, a font, or a lock screen displayed on the display.

The at least one processor according to an embodiment may be further configured to, when receiving the information on the at least one third image, also receive information on at least one of at least one icon image or at least one font image related to the first information.

The second image according to an embodiment may be displayed in a first area (for example, the first area 1301a of FIG. 13) of the execution screen of the first application, the the information on at least one third image may be displayed in a second area (for example, the second area 1301b) of the execution screen of the first application, and the first area and the second area may be different areas.

A method of controlling an electronic device (for example, the electronic device 101 of FIG. 1) according to an embodiment may include an operation of displaying a first image and one or more objects on a display, an operation of acquiring a second image in response to a first user input, an operation of acquiring first information based on the second image and a representing type of at least one of the one or more objects, an operation of transmitting the acquired first information to a server, an operation of receiving information on at least one third image related to the first information from the server, an operation of displaying the information on the at least one third image on the display; an operation of receiving a second user input for selecting the at least one third image, and an operation of changing the first image into the at least one third image and displaying the at least one third image on the display on the basis of the second user input.

The method of controlling the electronic device (for example, the electronic device 101 of FIG. 1) according to an embodiment may further include an operation of displaying an execution screen of a first application for searching for a recommended image, the execution screen of the first application including a first graphic object corresponding to a second application, an operation of receiving a third user input for selecting the first graphic object, an operation of executing the second application in response to the third user input, and an operation of acquiring the second image through the camera using the second application.

The first information according to an embodiment may include a first feature vector generated based on the second image and the representing type.

The at least one third image according to an embodiment may be found based on a determination of similarity between the first feature vector and feature vectors corresponding to a plurality of images stored in the server.

The determination of the similarity according to an embodiment may be based on a Euclidean distance or cosine similarity between the first feature vector and feature vectors corresponding to the plurality of images.

The one or more objects according to an embodiment may include at least one of one or more icons, a font, or a lock screen displayed on the display.

The operation of receiving the information on the at least one third image related to the first information from the server may include an operation of receiving information on at least one of at least one icon image or at least one font image related to the first information.

An electronic device (for example, the server 108 of FIG. 1) according to an embodiment may include a memory; and at least one processor, wherein the at least one processor may be configured to receive information a first image and a representing type of at least one object (for example, at least one icon 505a and 505b or at least one font 507a and 507b) displayed on a display (for example, the display device 160 of FIG. 1) of an external electronic device from the external electronic device (for example, the electronic device 101 of FIG. 1), generate first information (for example, the first feature vector 303 of FIG. 3B) based on the first image and the representing type, and transmit information (for example, the recommended theme information 305 of FIG. 3B) on at least one second image among a plurality of images stored in the memory to the external electronic device, on the basis of a determination of similarity using the generated first information.

The first information according to an embodiment may include a first feature vector (for example, the first feature vector 303 of FIG. 3B) generated using a customized model (for example, the customized model 205 of FIG. 3B) on the basis of the first image and the representing type, the plurality of images correspond to second feature vectors (for example, the second feature vector 217 of FIG. 3B) generated using the customized model, and the second feature vectors are generated based on at least one of a background image, a lock screen image, an icon image, a font image, or label information corresponding to each of the plurality of images.

The electronic device according to various embodiments may be one of various types of electronic devices. The electronic devices may include, for example, a portable communication device (e.g., a smart phone), a computer device, a portable multimedia device, a portable medical device, a camera, a wearable device, or a home appliance. According to an embodiment, the electronic devices are not limited to those described above.

It should be appreciated that various embodiments and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

Certain of the above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein.

While the present disclosure has been shown and described with reference to various embodiments thereof, it will be understood by those skilled in the art that various changes in form and details may be made therein without departing from the present disclosure as defined by the appended claims and their equivalents.

What is claimed is:

1. An electronic device comprising:
a display;
a memory; and
at least one processor,
wherein the at least one processor is configured to:
display a first image and one or more objects on the display,
acquire a second image in response to a first user input,
acquire first information based on the second image and a representing type of at least one object among the one or more objects,
transmit the acquired first information to a server,
receive information on at least one third image related to the first information from the server,
display the information on the at least one third image on the display,
receive a second user input for selecting one of the at least one third image, and
change the first image into the selected image and display the selected image, based on the second user input.

2. The electronic device of claim 1, further comprising a camera,
wherein the at least one processor is further configured to:
display an execution screen of a first application for searching for a recommended image on the display, the execution screen of the first application comprising a first graphic object corresponding to a second application,
receive a third user input for selecting the first graphic object,
execute the second application in response to the third user input, and
acquire the second image through the camera using the second application.

3. The electronic device of claim 1, wherein the first information comprises a first feature vector generated based on the second image and the representing type.

4. The electronic device of claim 3, wherein the first feature vector is generated based on a partial area of the second image.

5. The electronic device of claim 3, wherein the first feature vector is generated by combining first output data corresponding to the second image and second output data corresponding to the representing type.

6. The electronic device of claim 3, wherein the at least one third image is found based on a determination of similarity between the first feature vector and feature vectors corresponding to a plurality of images stored in the server.

7. The electronic device of claim 6, wherein the determination of the similarity is based on a Euclidean distance or cosine similarity between the first feature vector and the feature vectors corresponding to the plurality of images.

8. The electronic device of claim 1, further comprising a customized model,
wherein the customized model is generated through machine learning using a plurality of background images stored in the server, a plurality of lock screen images, a plurality of icon images, a plurality of font images, and/or label information for a pre-learned model stored in the server, and
wherein the at least one processor is configured to generate the first information, based on the second image and the representing type using the customized model.

9. The electronic device of claim 1, wherein the one or more objects comprise one or more icons, a font, and/or a lock screen displayed on the display.

10. The electronic device of claim 1, wherein the at least one processor is further configured to, when receiving the information on the at least one third image, also receive information on at least one icon image and/or at least one font image related to the first information.

11. The electronic device of claim 2,
wherein the second image is displayed in a first area of the execution screen of the first application,
wherein the information on the at least one third image is displayed in a second area of the execution screen of the first application, and
wherein the first area and the second area are different areas.

12. A method of controlling an electronic device, the method comprising:
displaying a first image and one or more objects on a display of the electronic device;
acquiring a second image in response to a first user input;
acquiring first information based on the second image and a representing type of at least one object among the one or more objects;
transmitting the acquired first information to a server;
receiving information on at least one third image related to the first information from the server;
displaying the information on the at least one third image on the display;
receiving a second user input for selecting one of the at least one third image; and
changing the first image into the selected image and displaying the selected image on the display, based on the second user input.

13. The method of claim 12, further comprising:
displaying an execution screen of a first application for searching for a recommended image on the display, the execution screen of the first application comprising a first graphic object corresponding to a second application;
receiving a third user input for selecting the first graphic object;
executing the second application in response to the third user input; and
acquiring the second image through a camera using the second application.

14. The method of claim 12, wherein the first information comprises a first feature vector generated based on the second image and the representing type.

15. The method of claim 14, wherein the at least one third image is found based on a determination of similarity between the first feature vector and feature vectors corresponding to a plurality of images stored in the server.

16. The method of claim 15, wherein the determination of the similarity is based on a Euclidean distance or cosine similarity between the first feature vector and the feature vectors corresponding to the plurality of images.

17. The method of claim 12, wherein the one or more objects comprise one of one or more icons, a font, and/or a lock screen displayed on the display.

18. The method of claim 12, wherein the receiving of the information on the at least one third image related to the first information from the server comprises receiving information on at least one icon image and/or at least one font image related to the first information.

19. An electronic device comprising:
a memory; and
at least one processor,
wherein the at least one processor is configured to:
receive information on a first image and a representing type of at least one object displayed on a display of an external electronic device from the external electronic device,
generate first information based on the first image and the representing type, and
transmit information on at least one second image among a plurality of images stored in the memory to the external electronic device, based on a determination of similarity using the generated first information.

20. The electronic device of claim 19,
wherein the first information comprises a first feature vector generated using a customized model, based on the first image and the representing type,
wherein the plurality of images correspond to second feature vectors generated using the customized model, and
wherein the second feature vectors are generated based on a background image, a lock screen image, an icon image, a font image, and/or label information corresponding to each of the plurality of images.
